(19) United States
(12) Patent Application Publication
(10) Pub. No.: US 2003/0071941 A1
(43) Pub. Date: Apr. 17, 2003

(54) LCD supporting structure

(75) Inventor: Hiromichi Mizuno, Kakegawa-Shi (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/270,662

(22) Filed: Oct. 16, 2002

(30) Foreign Application Priority Data
Oct. 16, 2001 (JP) 2001-318001

(51) Int. Cl. G02F 1/1335

(52) U.S. Cl. 349/96

(57) ABSTRACT

A back side polarizing plate adhered to a back side glass plate is formed into an extension region of a region where a right side glass plate and the back side glass plate do not overlap with each other. A liquid crystal display module is fixed to a light guide plate of a liquid crystal display back-lighting module by adhering a first region which is an outer periphery of a liquid crystal display and a second region which corresponds to the extension region of the back side polarizing plate to each other using double-faced adhesive tape. The double-faced adhesive tape is made up of a black PET (Polyethylene terephtalate) base material or a like having light blocking properties, and two adhesive layers formed respectively on both side surfaces of said black PET base material or the like.

### BACKGROUND OF THE INVENTION

1. Field of the Invention

The present invention relates to a structure for supporting an LCD (Liquid Crystal Display) used in a portable mobile communication apparatus such as a portable radio device, a PHS (Personal Handyphone System), a transceiver, or a portable information communication terminal, or a like.

The present application claims priority of Japanese Patent Application No.2001-318001 filed on Oct. 16, 2001, which is hereby incorporated by reference.

2. Description of the Related Art

Among mobile communication apparatuses, a demand for ,, which has been increasing rapidly in recent years, a cellular phone particularly for use in public communication is widely used by many individuals and various kinds of businesses owing to a fulfillment of communication services and a reduction in communication fees. The mobile communication apparatuses have been rapidly increasingly used not only in transmission/reception of speech but also in internet accessing and e-mailing, so that an LCD used therein tends to be increased in area owing to an increase of the number of characters displayed thereon. Furthermore, the mobile communication apparatuses have been improved steadily in reducing respectively the size and the weights, thus increasing a proportion, in size, of the LCD with respect to the overall mobile communication apparatus.

The LCD is used in a condition where it is connected with an LCD driver IC to control it in driving and displaying. Specifically, it is connected to the LCD in such a construction as TAB (Tape Auto Bonding), COF (Chip on Film), COG (Chip on Glass), or a like, among which the COG construction is used particularly in a cellular phone increasingly because this construction contributes to thinning thereof.

The LCD includes a combination of two glass plates and a liquid crystal material injected therebetween in such a configuration that a polarizing plate is adhered to each of right and back side surfaces of a combination of the two glass plates and a transparent electrode (ITO: Indium Tin Oxide) is formed on each of inner side surfaces of these two glass plates, in which an electrode portion used in connection with the LCD driver IC in the above-mentioned TAB, COF, or COG manner is disposed on only one of these two glass plates because the transparent electrode needs to be exposed.

Furthermore, the LCD includes an effective display area to secure regulated display, an active area in the effective display area to actually light up display contents, a seal area to seal the two glass plates, and a crimping area used in connection with the above-mentioned LCD driver IC, in such a configuration that those other than the active area are designed to be smaller in size in the mobile communicating apparatus in order to provide a larger display as much as possible. The polarizing plate in the LCD, which has an influence on its display performance, is actually adhered to the LCD surfaces up to the above-mentioned seal area to reduce cost to a minimum.

Furthermore, the LCD is positioned by an LCD frame formed in such a manner as to hold it so that the LCD may not be damaged by mechanical stresses such as falling impact, bending, or twisting. Note here that in some applications the LCD frame is integrated with a light-guide plate for illuminating the LCD. Typically the LCD and the LCD frame are fixed to each other by adhering with a double-faced adhesive tape the LCD frame and such part of the polarizing plate as to be outside the effective display area, which part does not come in the above-mentioned effective display area.

By this conventional technology, however, since the LCD is designed to be small except in the active area, since the LCD and the LCD frame cannot securely be fixed to each other because an area of the double-faced adhesive tape where the LCD and the LCD frame are fixed to each other is quite small due to fluctuations in public allowance of the external LCD sizes and of the polarizing plate pasting position, and even since there is no part of the polarizing plate nor part of the double-faced adhesive tape available for adhesion at a mechanically weakest portion of a single glass-plate portion in the LCD on which the LCD driver IC is mounted in the COG manner, if mechanical stresses such as fall impacting, bending, or twisting are applied to a mobile communication apparatus incorporating the LCD, the LCD is dislodged from the LCD frame to thereby have the mechanical stress concentrated thereon, so that a crack or crazing may readily occur in the LCD or the LCD driver IC because the glass cannot easily follow external force by nature, thus making it impossible to confirm display in some cases.

### SUMMARY OF THE INVENTION

In view of the above, it is an object of the present invention to provide an LCD supporting structure which prevents an LCD and an LCD driver IC from being fallen or lifted and also from encountering a crack or crazing even if mechanical stresses such as falling impact, bending, or twisting are applied to the LCD frame.

According to a first aspect of the present invention, there is provide an LCD supporting structure including:

an overlapping region where two glass plates opposite to each other making up an LCD overlap with each other and a non-overlapping region where one of the two glass plates do not overlap with an another of the two glass plates to thereby support, by adhering and fixing, an LCD module of a COG (chip on glass) construction on which a driver for driving the LCD is mounted in the non-overlapping region to an LCD back-lighting module having a light source and a light guide member which guides light emitted from the light source to the LCD,

wherein a polarizing plate is provided over both the overlapping region and the non-overlapping region of the one of the two glass plates where the driver is mounted, so that part of the polarizing plate that exists in the non-overlapping region is used as an adhered/fixed face at which the liquid crystal display module is adhered and fixed to the liquid crystal display back-lighting module.

In the foregoing first aspect, a preferable mode is one wherein part of the polarizing plate that exists in the non-overlapping region is used as at least one part of an adhered/fixed face at which the liquid crystal display module is adhered and fixed to the liquid crystal display back-lighting module.

Another preferable mode is one wherein an outer periphery of the polarizing plate corresponding to an outer periphery of the liquid crystal display module is used as at an other part of an adhered/fixed face at which the liquid crystal display module is adhered and fixed to the liquid crystal display back-lighting module.

Still another preferable mode is one wherein the polarizing plate of the LCD module is adhered and fixed to the LCD back-lighting module using double-faced adhesive tape having light-blocking properties.

According to a second aspect of the present invention, there is provided an LCD supporting structure including;

an overlapping region where two glass plates opposite to each other making up an LCD overlap with each other and a non-overlapping region where one of the two glass plates do not overlap with an another of the two glass plates to thereby support, by adhering and fixing, an LCD module of a COG (chip on glass) construction on which a driver for driving the LCD is mounted in the non-overlapping region to an LCD back-lighting module having a light source and a light guide member which guides light emitted from the light source to the LCD,

wherein a plate member having roughly a same thickness as a polarizing plate provided in the overlapping region is provided in the non-overlapping region of the one of two glass plates to which the driver is mounted, so that the plate member that exists in the non-overlapping region is used as an adhered/fixed face at which the liquid crystal display module is adhered and fixed to the liquid crystal display back-lighting module.

In the foregoing second aspect, a preferable mode is one wherein the plate member that exists in the non-overlapping region is used as at least one part of an adhered/fixed face at which the liquid crystal display module is adhered and fixed to the liquid crystal display back-lighting module.

Another preferable mode is one wherein an outer periphery of the polarizing plate corresponding to an outer periphery of the liquid crystal display module is used as at an other part of an adhered/fixed face at which the liquid crystal display module is adhered and fixed to the liquid crystal display back-lighting module.

Still another preferable mode is one wherein the polarizing plate and the plate member of the LCD module are adhered and fixed to the LCD back-lighting module using double-faced adhesive tape having light-blocking properties.

According to a third aspect, there is provided a liquid crystal display supporting structure comprising an overlapping region where two glass plates opposite to each other making up a liquid crystal display overlap with each other and non-overlapping regions where the two glass plates do not overlap with each other, and adhering and filling a liquid crystal display module of a COG (chip on glass) construction on which a driver for driving the liquid crystal is mounted in at least one of the non-overlapping regions to a liquid crystal display back-lighting module having a light source and a light guide member which guides light emitted from the light source to the liquid crystal,

wherein a polarizing plate is provided over both the overlapping region and the non-overlapping region of one of the two glass plates, so that part of the polarizing plate that exists in the non-overlapping region is used as an adhered/fixed face at which the liquid crystal display module is adhered and fixed to the liquid crystal display back-lighting module.

In the foregoing third aspect, a preferable mode is one wherein part of the polarizing plate that exists in the non-overlapping region is used as at least one part of an adhered/fixed face at which the liquid crystal display module is adhered and fixed to the liquid crystal display back-lighting module.

According to a fourth aspect, there is provided a liquid crystal display supporting structure comprising an overlapping region where two glass plates opposite to each other making up a liquid crystal display overlap with the each other and non-overlapping regions where the two glass plates do not overlap with each other, and adhering and fixing a liquid crystal display module of a COG (chip on glass) construction on which a driver for driving the liquid crystal display is mounted in at least one of the non-overlapping regions to a liquid crystal display back-lighting module having a light source and a light guide member which guides light emitted from the light source to the liquid crystal display,

wherein a plate member having roughly a same thickness as a polarizing plate provided in the overlapping region is provided in the non-overlapping region of one of the two glass plates, so that the plate member is used as an adhered/fixed face at which the liquid crystal display module is adhered and fixed to the liquid crystal display back-lighting module. In the foregoing fourth aspect, a preferable mode is one wherein the plate member is used as at least one part of an adhered/fixed face at which the liquid crystal display module is adhered and fixed to the liquid crystal display back-lighting module.

With the configuration as above, there is disposed a polarizing plate even in such a region of one of two glass plates to which the driver is mounted that the one of two glass plates do not overlap with an another of two glass plates. Specifically, the polarizing plate is provided as extended into a region in which the one of two glass plates do not overlap with the another of two glass plates, that is, which does not contribute to display on the LCD, so that such part of the polarizing plate as to exist in this extended portion is used as an adhesion/ fixing face.

Therefore, in contrast to the conventional supporting structure in which a polarizing plate provided only in the region where the two glass plates overlap with each other is used as the adhered/fixed face to adhere and fix an LCD module to an LCD back-lighting module. The structure of the present claim increases an area of the adhered/fixed face by as much as the extension of the polarizing plate.

With another configuration as above, there is provided a plate member having almost the same thickness as that of a polarizing plate provided in a region where the two glass plates overlap with each other in such a region of one of the glass plates to which the driver is mounted that the one of two glass plates do not overlap with an another of the two glass plates. That is, in contrast to the conventional supporting structure in which the polarizing plate provided in the region where the two glass plates overlap with each other is used as the adhered/fixed face to adhere and fix the LCD module to the LCD back-lighting module, the structure of the present claim can use also the plate member on the extension as the adhered/fixed face, thus increasing the area of the adhered/fixed face by as much as this plate member.

### BRIEF DESCRIPTION OF THE DRAWINGS

The above and other objects, advantages, and features of the present invention will be more apparent from the following description taken in conjunction with the accompanying drawings, in which:

FIGS. 1A and 1B are a top view and a side view respectively for showing an LCD module supported by an LCD supporting structure according to a first embodiment of the present invention;

FIGS. 2A and 2B are a top view and a side view respectively for showing an LCD back-lighting module which supports the LCD module by utilizing the LCD supporting structure of the first embodiment of the present invention;

FIG. 3 is a cross-sectional view showing a state where the LCD module, the LCD back-lighting module, and a printed circuit board are connected to each other, for explaining the LCD supporting structure of the first embodiment of the present invention;

FIGS. 4A and 4B are a top view and a side view respectively for showing an LCD module supported by an LCD supporting structure of a second embodiment of the present invention; and

FIGS. 5A and 5B are a top view and a side view for showing one example of a conventional LCD module.

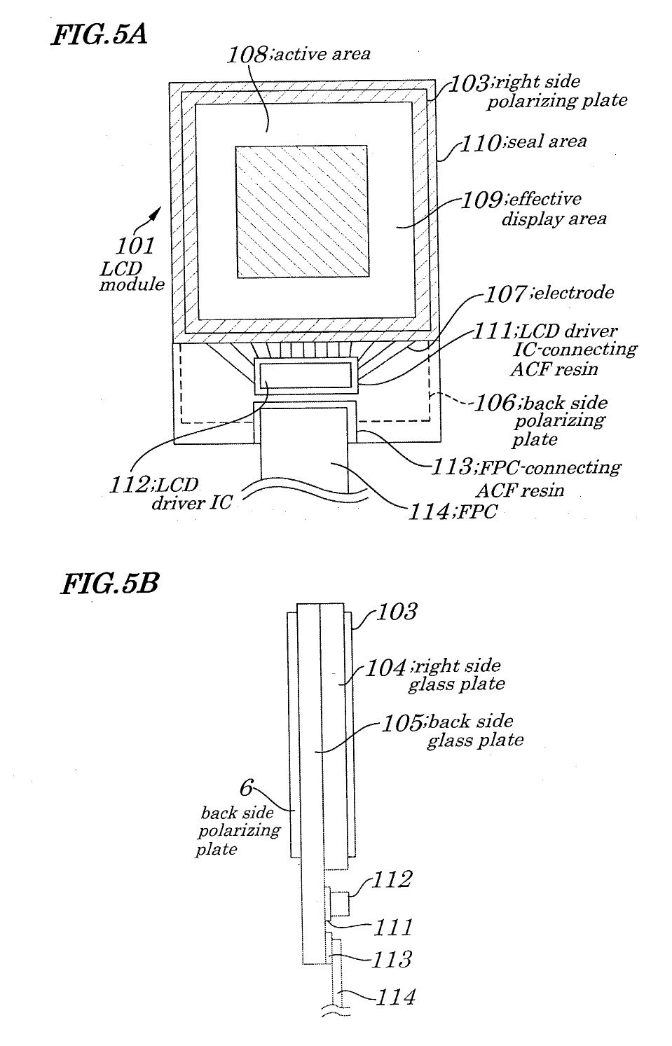

### DESCRIPTION OF THE PREFERRED EMBODIMENTS

Best modes of carrying out the present invention will be described in further detail using various embodiments with reference to the accompanying drawings.

### First Embodiment

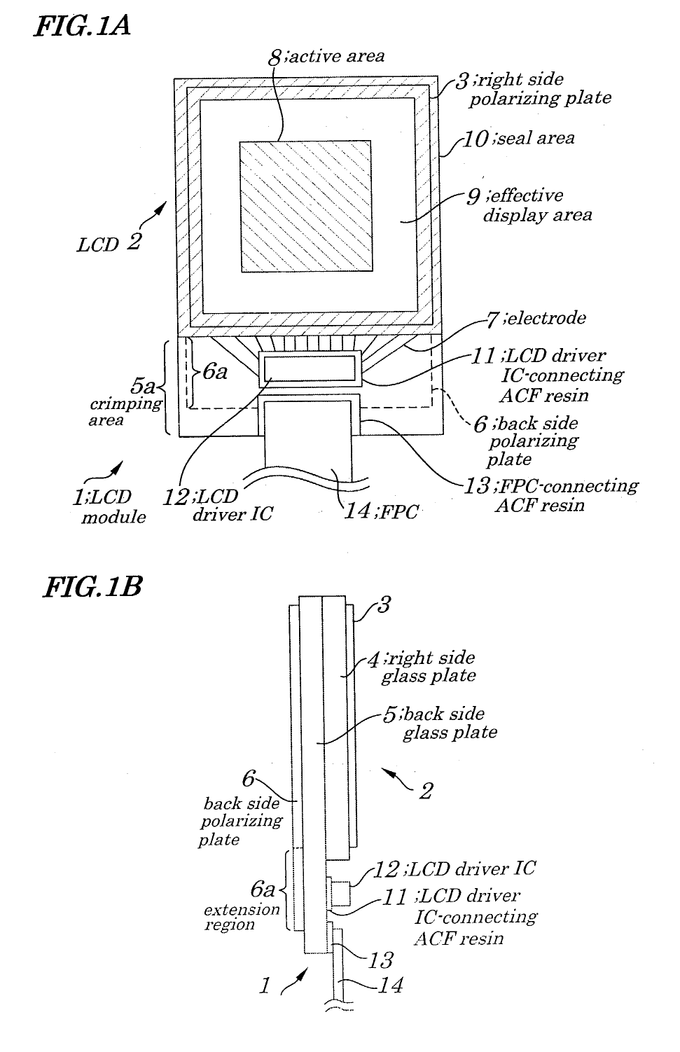

As shown in FIGS. 1A and 1B, an LCD module 1 includes: a right side glass plate 4 and a back side glass plate 5 between which a liquid crystal (not shown) is injected and to which surfaces a right side polarizing plate 3 and a back side polarizing plate 6 are adhered respectively; an electrode 7 which provides a transparent electrode (Indium Tin Oxide) formed on each of inner side surfaces of the right side glass plate 4 and the back side glass plate 5; and an LCD driver IC 12 to drive an LCD 2.

Since the LCD module 1 of the present embodiment is of a COG construction, the electrode 7 needs to be e posed at such an electrode portion as to be used to connect the LCD 2 to an IC (not shown), so that only one glass plate is used in construction. That is, in the LCD module 1, the back side glass plate 5 is made larger than the right side glass plate 4 by as much as a crimping area 5a to expose the electrode 7 and also to mount the LCD driver IC 12 thereon in such a construction that the crimping area 5a is disposed on only one of the two glass plates 4, 5.

Furthermore, the LCD module 1 is divided into an effective display area 9 where regulated display is secure, an active area 8 where contents in the effective display area 9 are actually lit up, a seal area 10 where the two glass plates 4, 5 are sealed, and the crimping area 5a where the LCD driver IC 12 is connected, in which these areas other than the active area 8 are designed to be small in size as much as possible so that the contents on the LCD 2 may appear large with respect to the size of a mobile communication apparatus. Note here that the active area 8, the effective display area 9, and the seal area 10 are contained in a region where the right side glass plate 4 and the back side glass plate 5 overlap with each other, while the crimping area 5a is contained in a region where they do not overlap with each other.

The right side polarizing plate 3 is adhered to the surface of the right side glass plate 4 and the back side polarizing plate 6 is adhered to the surface of the back side glass plate 5 in such a manner that the right side polarizing plate 6 is formed up to an extension region 6a where the right side glass plate 4 and the back side glass plate 5 do not overlap with each other. In contrast, in a conventional LCD a right side polarizing plate and a back side polarizing plate are adhered in such a manner as not to go out of a seal area, whereas in the present embodiment, the back side polarizing plate 6 is adhered as extended to a portion where only the back side glass plate 5 exists and also where the LCD driver IC 12 is mounted in the COG manner.

The crimping area 5a of the back side lass plate 5 is mounted with the LCD driver IC 12 as well as an FPC (Flexible Printed Circuit) 14 which supplies an external signal and power to the LCD driver IC 12, in such a configuration that the LCD driver IC 12 is thermally adhered under pressure using an LCD driver IC-connecting ACF (Activated Carbon Fiber) resin 11 of an anisotropic conductive film and the FPC 14 is also thermally adhered under pressure using an FPC-connecting ACF resin 13 of the anisotropic conductive film so that they may be connected to an LCD 2 electrically and physically. Note here that the LCD 2 given in the present specification refers to the display functioning portion of the LCD 2 including the active area 8 and the effective display area 9.

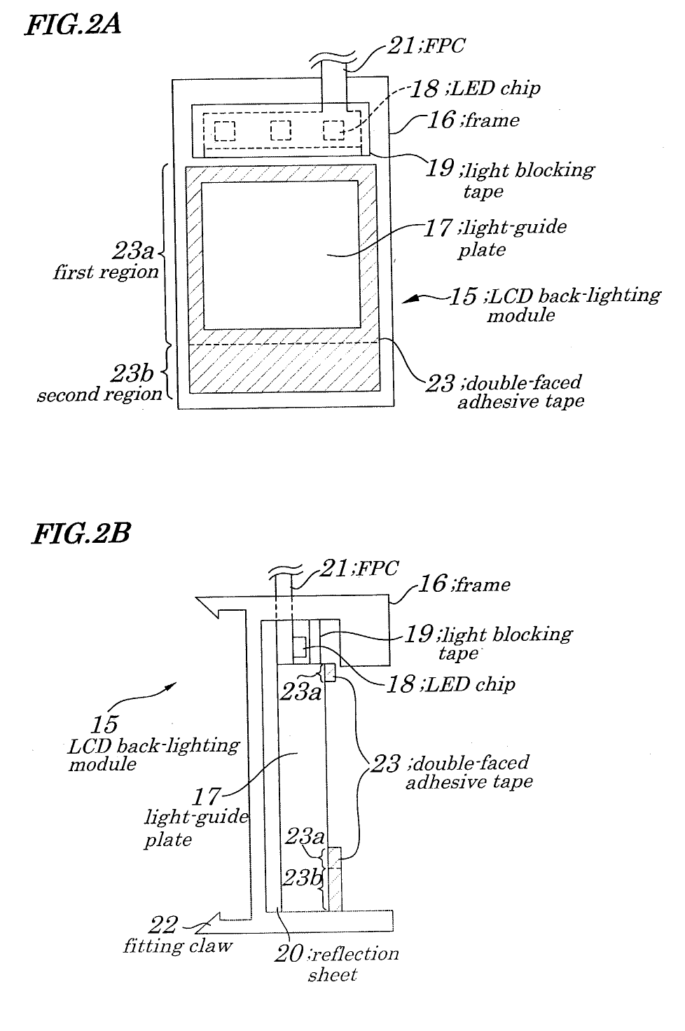

As shown in FIGS. 2A and 2B an LCD back-lighting module 15 includes a light-source LED chip 18, a light-guide plate 17 to guide light radiated from the LED chip 18, and a frame 16 to determine a position of the LCD module 1 and fix the light guide plate 17.

To the surface of the light guide plate 17 on which the LCD module 1 (FIG. 1B) is mounted, a double-faced adhesive tape 23 (hatched portion in the FIGS. 2A and 2B) to adhere and fix the LCD module 1 is adhered, while on the opposite surface, a reflection sheet 20 is adhered. The double-faced adhesive tape 23 is adhered to a first region 23a, which (as shown in FIGS. 1A and 1B) is an outer periphery of the LCD 2, to such an ex-tent that it may not come in the effective display area 9 of the LCD 2 and also to a second region 23b which corresponds to the e-:tension region 6a of the back side polarizing plate 6. As the double-faced adhesive tape 23 of the embodiment, for example, it is preferably to use one which is made up of a black PET (Polyethylene terephtalate) base material or a like, and two adhesive layers formed respectively on both side surfaces of the black PET base material or the like, or the black PET base material or a like, and an another kind of double-faced adhesive tapes adhered respectively on both side surfaces of the black PET base material or the like, in order to prevent the LCD driver IC 12 from malfunctioning due to an entry of light.

The LED chip 18 is mounted on an FPC 21 and has a light blocking tape 19 adhered to the right side surface thereof.

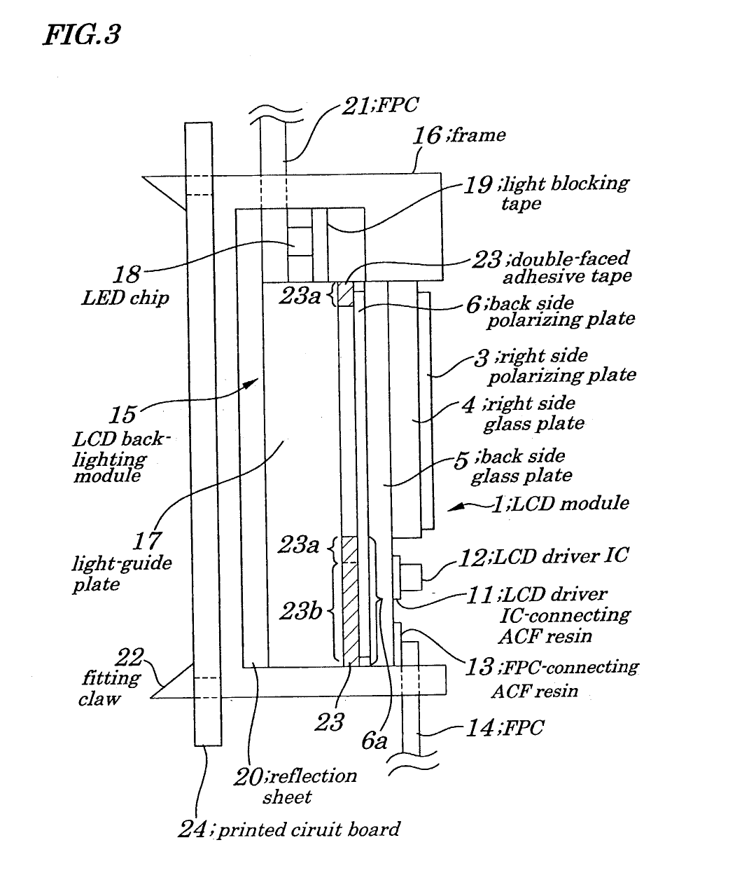

The frame 16 is provided with a fitting claw 22 to fit it to a printed circuit board 24 (see FIG. 3). The frame 16 is made of a resin material such as ABS, PPS (Polyphenylene Sulfide), or a like that can tolerate an external impact sufficiently.

FIG. 3 is a cross-sectional view showing a state where the LCD module, the LCD back-lighting module, and a printed circuit board are connected to each other, for explaining the LCD supporting structure according to this embodiment.

The LCD back-lighting module 15 and the printed circuit board 24 are coupled with each other by the fitting claw 22 mechanically.

Furthermore, the LCD module 1 and the LCD back-lighting module 15 are adhered to each other by the double-faced adhesive tape 23. That is, the double-faced adhesive tape 23 adheres and fixes the back side polarizing plate 6 and the light guide plate 17 to each other not only in the outer periphery (first region 23a in the figure) of the LCD 2 as in the case of the conventional embodiment but also in the extension region 6a of the back side polarizing plate 6 and such a region (second region 23b in the FIGS. 2A and 2B) of the light guide plate 17 as to correspond to this extension region 6a.

Thus, in the LCD supporting structure of the present embodiment, the back side polarizing plate 6 is adhered as extended to such a portion as to correspond to the crimping area 5a of the back side glass plate 5 where the LCD driver IC 12 is mounted in the COG manner, so that an adhesion area in which the LCD module 1 and the LCD back-lighting module 15 are adhered to each other by the double-faced adhesive tape 23 is increased by as much as the extension region 6a of the back side polarizing plate 6, that is, as much as the second region 23b. Accordingly, the LCD module 1 and the LCD back-lighting module 15 are fixed. to each other more strongly, so that the LCD module 1 is not dislodged from the frame 16 even if stress is applied to the frame 16 when mechanical stresses such as falling impact, bending, twisting are applied to a portable communication apparatus in which the LCD module 1 is mounted. In such a manner, the LCD module 1 is not dislodged from the frame 16 to thereby inhibit mechanical stresses such as warping or flexing from being applied to the right glass plate 4, the back side glass plate 5, or the LCD driver IC 12, which cannot easily follow external force, so that it is possible not only to prevent the LCD 2 and the LCD driver IC 12 from being dislodged or coming off in any place but also to prevent a crack or damage from occurring therein.

### Second Embodiment

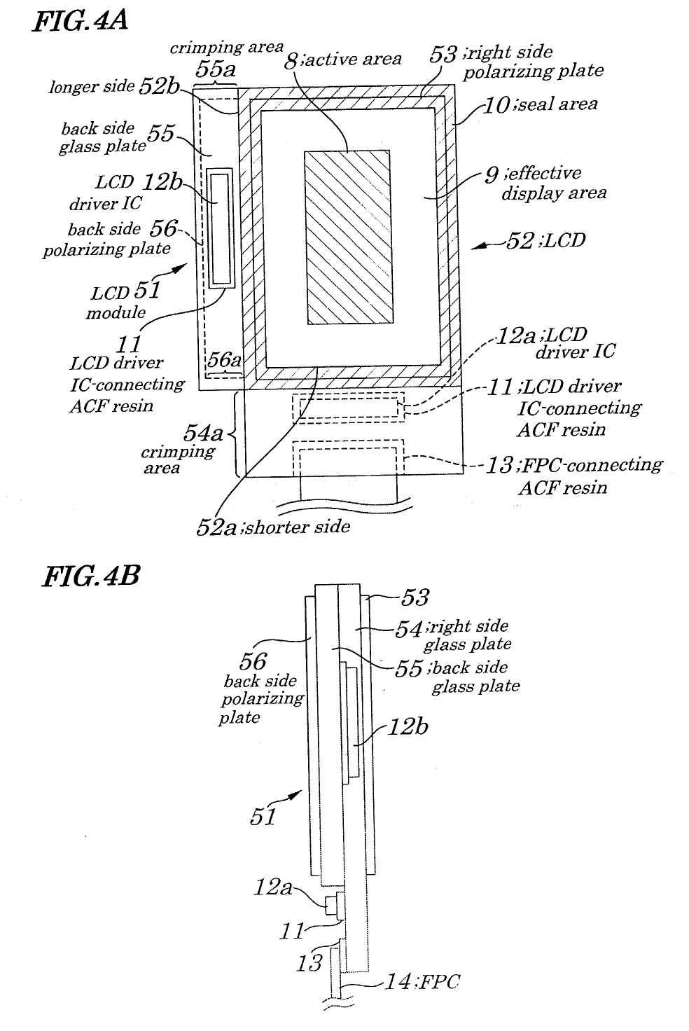

Note here that components of the second embodiment in FIG. 4 which are similar to those of the first embodiment are indicated by the same reference numbers as those used in the first embodiment. Also note here that in the following description, the components of the present embodiment which are similar to those of the first embodiment are described using the reference numbers used in the first embodiment.

An LCD module 51 of the present embodiment includes a right side glass plate 54 having its crimping area 54a formed on a side of a shorter side 52a of a rectangular LCD 52 and a back side glass plate 55 having its crimping area 55a formed on a longer side 52b of the LCD 52 in such a configuration that an LCD driver IC 12a is mounted on the side of a back side glass plate 55 in the crimping area 55a and an LCD driver IC 12b is mounted on the side of the right side glass plate 54 in the crimping area 55a.

Furthermore, an extension region 56a of a back side polarizing plate 56 is formed in a region which corresponds to the crimping area 55a, that is, on the side of the longer side 52b of the LCD 52.

Note here that the LCD module 51 of the present embodiment basically has almost the same configuration as that of the LCD module 1 described with the first embodiment and so its detailed description is omitted here.

In the present embodiment, the LCD 52 is rectangular in geometry, so that its longer side 52b is mechanically weaker than its shorter side 52a against external mechanical stresses in construction. To guard against this, in the present embodiment, the extension region 56a is provided on the side of the longer side 52b to further strengthen fixation between the LCD module 51 and a LCD back-lighting module 15 (FIG. 2B) on the side of the longer side 52b.

That is, as in the case of the first embodiment, in the LCD supporting structure of the present embodiment, the back side polarizing plate 56 and a light guide plate 17 (FIG. 2A) are adhered and fixed by the both-faced adhesive tape 23 at the outer periphery of the LCD 52, in addition to which the extension region 56a of the back side polarizing plate 56 and such a region of the light guide plate 17 as to correspond to this extension region 56a are also adhered and fixed by the both-faced adhesive tape 23. Accordingly, the LCD module 51 is not dislodged from the frame 16 even if mechanical stresses such as falling impact, bending, or twisting are applied to a portable communication apparatus in which the LCD module 51 is mounted and as well as stresses is applied to the frame 16. Therefore, the LCD module 51 is not dislodged from the frame 16, so that mechanical stresses such as warping or flexing have no influence on the right side glass plate 54, the back side glass plate 55, or the LCD driver 12a or 12b, thus making it possible not only to prevent the LCD 2 and the LCD drivers 12a and 12b from being fallen or lifted but also to prevent cracking or damage from occurring as in the case of the first embodiment.

Although the above-mentioned embodiments have preserved the LCD adhering area by extending the back side polarizing plate, almost the same effects can be obtained by pasting a structure having roughly the same thickness as that of the polarizing plate in place of the extended polarizing plate in order to increase the area of the adhered/fixed face.

It is apparent that the present invention is not limited to the above embodiments but may be changed and modified without departing from the scope and spirit of the invention.

For example, the LCD supporting structure is not only applied to a cellular phone but may be implemented similarly in any of the configurations described with the above-mentioned embodiments as far as the relevant portable communication apparatus is provided with the LCD in which the LCD driver IC is mounted in the COG manner, thus providing almost the same effects as those described above. Furthermore, almost the same effects as those described above can be obtained in any of the STN, TN, TFT, and TFD constructions employed in the LCD.

According to the present invention, the polarizing plate is provided as extended in a region not contributing to display on the LCD where the two glass plates do not overlap with each other, so that the extended portion of the polarizing plate can be used as the adhered/fixed face to increase the area of the adhered/fixed face of the LCD module with respect to the LCD back-lighting module, thus further strengthening the fixation of the LCD module. By this configuration, even if mechanical stresses are applied to the frame in which the LCD module is mounted, the LCD module is not dislodged from the frame, so that the mechanical stresses have no influence on the glass plate of the LCD or the LCD driver IC, which cannot easily follow external force, thus not only preventing the LCD or the LCD driver IC from being fallen or lifted but also preventing a crack or flaw from occurring.

What is claimed is:

1. A liquid crystal display supporting structure comprising an overlapping region where two glass plates opposite to each other making up a liquid crystal display overlap with each other and a non-overlapping region where one of said two glass plates do not overlap with an another of said two glass plates, and adhering and fixing a liquid crystal display module of a COG (chip on glass) construction on which a driver for driving said liquid crystal is mounted in said non-overlapping region to a liquid crystal display back-lighting module having a light source and a light guide member which guides light emitted from said light source to said liquid crystal,
wherein a polarizing plate is provided over both said overlapping region and said non-overlapping region of said one of said two glass plates where said driver is mounted, so that part of said polarizing plate that exists in said non-overlapping region is used as an adhered/fixed face at which said liquid crystal display module is adhered and fixed to said liquid crystal display back-lighting module.

2. The liquid crystal display supporting structure according to claim 1, wherein part of said polarizing plate that exists in said non-overlapping region is used as at least one part of an adhered/fixed face at which said liquid crystal display module is adhered and fixed to said liquid crystal display back-lighting module.

3. The liquid crystal display supporting structure according to claim 2, wherein an outer periphery of said polarizing plate corresponding to an outer periphery of said said overlapping region is used as at an other part of an adhered/fixed face at which said liquid crystal display module is adhered and fixed to said liquid crystal display back-lighting module.

4. The liquid crystal display supporting structure according to claim 1, wherein said polarizing plate of said liquid crystal display module is adhered and fixed to said liquid crystal display back-lighting module using double-faced adhesive tape having light-blocking properties.

5. A liquid crystal display supporting structure comprising an overlapping region where two glass plates opposite to each other making up a liquid crystal display overlap with said each other and a non-overlapping region where one of said two glass plates do not overlap with an another of said two glass plates, and adhering and fixing a liquid crystal display module of a COG (chip on glass) construction on which a driver for driving said liquid crystal display is mounted in said non-overlapping region to a liquid crystal display back-lighting module having a light source and a light guide member which guides light emitted from said light source to said liquid crystal display,
wherein a plate member having roughly a same thickness as a polarizing plate provided in said overlapping region is provided in said non-overlapping region of said one of said two glass plates, so that said plate member is used as an adhered/fixed face at which said liquid crystal display module is adhered and fixed to said liquid crystal display back-lighting module.

6. The liquid crystal display supporting structure according to claim 5, wherein said plate member is used as at least one part of an adhered/fixed face at which said liquid crystal display module is adhered and fixed to said liquid crystal display back-lighting module.

7. The liquid crystal display supporting structure according to claim 5, wherein an outer periphery of said polarizing plate corresponding to an outer periphery of said overlapping region is used as at an other part of an adhered/fixed face at which said liquid crystal display module is adhered and fixed to said liquid crystal display back-lighting module.

8. The liquid crystal display supporting structure according to claim 5, wherein said polarizing plate and said member of said LCD module are adhered and fixed to said liquid crystal display back-lighting module using double-faced adhesive tape having light-blocking properties.

9. A liquid crystal display supporting structure comprising an overlapping region where two glass plates opposite to each other making up a liquid crystal display overlap with each other and non-overlapping regions where said two glass plates do not overlap with each other, and adhering and fixing a liquid crystal display module of a COG (chip on glass) construction on which a driver for driving said liquid crystal is mounted in at least one of said non-overlapping regions to a liquid crystal display back-lighting module having a light source and a light guide member which guides light emitted from said light source to said liquid crystal,
wherein a polarizing plate is provided over both said overlapping region and the non-overlapping region of one of said two glass plates, so that part of said polarizing plate that exists in said non-overlapping region is used as an adhered/fixed face at which said liquid crystal display module is adhered and fixed to said liquid crystal display back-lighting module.

10. The liquid crystal display supporting structure according to claim 9, wherein part of said polarizing plate that exists in said non-overlapping region is used as at least one part of an adhered/fixed face at which said liquid crystal display module is adhered and fixed to said liquid crystal display back-lighting module.

11. The liquid crystal display supporting structure according to claim 9, wherein an outer periphery of said polarizing plate corresponding to an outer periphery of said overlapping region is used as at an other part of an adhered/fixed face at which said liquid crystal display module is adhered and fixed to said liquid crystal display back-lighting module.

12. The liquid crystal display supporting structure according to claim 9, wherein said polarizing plate of said liquid crystal display module is adhered and fixed to said liquid crystal display back-lighting module using double-faced adhesive tape having light-blocking properties.

13. A liquid crystal display supporting structure comprising an overlapping region where two glass plates opposite to each other making up a liquid crystal display overlap with said each other and non-overlapping regions where said two glass plates do not overlap with each other, and adhering and fixing a liquid crystal display module of a COG (chip on glass) construction on which a driver for driving said liquid crystal display is mounted in at least one of said non-overlapping regions to a liquid crystal display back-lighting module having a light source and a light guide member which guides light emitted from said light source to said liquid crystal display,
wherein a plate member having roughly a same thickness as a polarizing plate provided in said overlapping region is provided in the non-overlapping region of one of said two glass plates, so that said plate member is used as an adhered/fixed face at which said liquid crystal display module is adhered and fixed to said liquid crystal display back-lighting module.

14. The liquid crystal display supporting structure according to claim 13, wherein said plate member is used as at least one part of an adhered/fixed face at which said liquid crystal display module is adhered and fixed to said liquid crystal display back-lighting module.

15. The liquid crystal display supporting structure according to claim 13, wherein an outer periphery of said polarizing plate corresponding to an outer periphery of said overlapping region is used as at an other part of an adhered/fixed face at which said liquid crystal display module is adhered and fixed to said liquid crystal display back-lighting module.

16. The liquid crystal display supporting structure according to claim 13, wherein said polarizing plate and said plate member of said LCD module are adhered and fixed to said liquid crystal display back-lighting module using double-faced adhesive tape having light-blocking properties.
